(19) United States
(12) Patent Application Publication
(10) Pub. No.: US 2014/0342914 A1
(43) Pub. Date: Nov. 20, 2014

(54) Method of Plant Growth with Bifenthrin

(71) Applicant: FMC Corporation, Philadelphia, PA (US)

(72) Inventors: Houston P. Joost, Greenbrae, CA (US); Henry Van Tuyl Cotter, Raleigh, NC (US); Alison Burnett, Philadelphia, PA (US); Thomas E. Anderson, Yardley, PA (US)

(73) Assignee: FMC Corporation, Philadelphia, PA (US)

(21) Appl. No.: 14/265,574

(22) Filed: Apr. 30, 2014

Related U.S. Application Data
(60) Provisional application No. 61/823,442, filed on May 15, 2013.

(51) Int. Cl. A01N 37/08

(52) U.S. Cl. CPC A01N 37/08
USPC 504/319

(57) ABSTRACT

The present invention is directed to a method of improving the growth of a plant comprising applying a plant growth effective amount of bifenthrin to the propagation material of such plant in the absence of insect pest pressure.

### FIELD OF THE INVENTION

The present invention is directed to a method of improving the growth of a plant comprising applying a plant growth effective amount of bifenthrin to the propagation material of such plant in the absence of insect pest pressure.

### BACKGROUND OF THE INVENTION

Due to the world's increasing population and decreasing amount of arable land, there is a pressing need for methods to increase the productivity of agricultural crops. Given this need to produce increased amounts of food and feed, plants are increasingly being grown in varied locations and/or under climactic conditions in which insect pressure does not exist. For example, more and more crops are being produced in greenhouses or other shelters where insect pressures can be easily minimized. Plants with increased cold and/or drought tolerance are being developed which may eventually permit them to grow under climactic conditions which are inhospitable to their traditional insect pests.

It has been disclosed that certain fungicides or fungicidally active materials will increase plant growth in the absence of fungicidal and/or bacterial pressure. Thus, Asrar et al (U.S. Pat. No. 7,098,170) disclose that certain diazole fungicides, triazole fungicides and strobilurin-type fungicides will increase the vigor and/or yield of plants in the absence of pest pressure by fungal pathogens. Somewhat similarly, Frank et al (US Patent Application 2012/0094834) disclose that Bacillus subtilis strain NRRL B-21661, optionally when mixed with any of a large number of agriculturally active chemicals (including bifenthrin), will increase plant vigor and/or yield in the absence of fungal and bacterial pathogens.

However, ensuring the absence of fungal and/or bacterial pathogens/pressure is difficult and impractical in many circumstances. Soil normally contains such pathogens and would need to be effectively sterilized; fungal and bacterial spores can travel vast distances on wind currents and thus air flow would need to be effectively filtered or otherwise treated to ensure an absence of fungal and/or bacterial pathogens. In contrast, exclusion of insect pressure is much more easily and economically achieved.

Bifenthrin is a pyrethroid insecticide which has been shown to be effective against a large number of insect pests including aphids, chinch bugs, grasshoppers, Japanese beetles, stink bugs, corn rootworm, wireworms and many other insect pests. Bifenthrin controls insects by delaying the closing of the sodium channel in their central and peripheral nervous system—a mode of action which is completely irrelevant to plants. Thus, in the past, one would have had no motivation to apply bifenthrin in the absence of insect pressure, since one would assume that such application would be completely ineffectual and costly, Consequently, it is completely unexpected that bifenthrin would have a positive effect on the growth of plants when applied to plant propagative material in the absence of insect pest pressure.

### DETAILED DESCRIPTION OF THE INVENTION

The present invention is directed to a method of improving the growth of a plant comprising applying a plant growth effective amount of bifenthrin to the propagation material of such plant in the absence of insect pest pressure.

The chemical name for bifenthrin is 2-methylbiphenyl-3-ylmethyl (Z)-(1RS)-cis-3-(2-chloro-3,3,3-trifluoroprop-1-enyl)-2,2-dimethyl cyclopropanecarboxylate.

As is employed herein, the term “plant growth effective amount” refers to an amount of bifenthrin which will increase the growth and or vigor of the plant to an extent exceeding that of identical plants not treated with bifenthrin. It is preferred that the rate of application of bifenthrin be in the range of from about 4 grams of active per hectare (g ai/ha) to about 1200 g ai/ha, more preferably in a range of from about 4 g ai/ha to about 300 g ai/ha.

As is employed herein the term “plant propagation material” includes plant seeds, cuttings, sets, rhizomes, tubers, meristem tissue, single and multiple plant cells, and any other plant tissue from which a complete plant can be obtained.

The term “in the absence of insect pest pressure” includes situations in which insect pests are not present in the growth area of a plant, as well as situations where such insect pests are present within the area of growth of a plant but in a quantity which is not harmful to the plant and which does not interfere with the growth of the plant.

The improved plant growth obtained employing the method of this invention includes increased root length, increased shoot length and increased seedling weight, relative to plants which have not been so treated.

In the practice of the present invention, the bifenthrin may be employed in the form of technical material or in the form of any standard agriculturally acceptable formulation thereof. Commercial formulations of bifenthrin which may be employed include CAPTURE®LFR Insecticide, Brigade® 2EC and WSB Insecticide/Miticid, and Talstar® P Professional Insecticide all available from FMC Corporation.

As is employed herein, the term “plants” includes agricultural, silvicultural and horticultural (including ornamental) plants. The term “plants” also includes plants which have been recombinant DNA techniques makes modifications possible that cannot readily be obtained modified by breeding, mutagenesis or genetic engineering. Genetically modified plants are plants, which genetic material has been modified by the use of recombinant DNA techniques. The use of by cross breeding under natural circumstances, mutations or natural recombination.

Preferred plants which may be treated in the process of this invention include brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese waxgourd, citron melon, cucumber, gherkin, gourd, muskmelons (including cantalope, casaba, crenshaw melon, golden pershaw melon, honeydew melon, honey balls, mango melon, Persian melon, pineapple melon, Santa Claus melon and snake melon), pumpkins, summer squash, winter squash and watermelon; dried beans and peas, including bean, field bean, kidney bean, lima bean, pinto bean, navy bean, tepary bean, adzuki bean, blackeyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok choy, collards, kale, mizuna, mustard spinach, rape greens and turnip greens; okra; peppers; sod; soybeans; spinach; succulent peas and beans including pea, dwarf pea, edible-pod pea, English pea, garden pea, green pea, snow pea, sugar snap pea, [ppigeon pea, bean, broadbean, lima bean, runner bean, snap bean, wax bean, asparagus bean, yardlong bean, jackbean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean and true yam.

The bifenthrin may be applied to the propagative material by any means, including direct application, as a seed treatment, in furrow or band applications, by means well known to those in the art.

### EXAMPLES

The following Examples are intended to illustrate the invention and are not intended to limit the invention in any manner whatsoever.

### Example 1

### Corn Seedling Growth Enhancement Using CAPTURE® LFR Insecticide

Ten corn seeds (Pioneer variety 33M53, treated with PONCHO® 250 Insecticide) were evenly spaced in a single, 2 cm deep, furrow in a planter box (25.5 cm by 11.5 cm) containing steam treated loam soil (pH 6.4, 4.3% organic matter. An aqueous suspension of CAPTURE® LFR Insecticide (17.5% bifenthrin) was sprayed as a T-band in-furrow application onto the uncovered seeds at a rate of 269 g ai/ha using a DeVries overhead track sprayer at a pressure of 40 psi and an application volume of 200 l/ha. The seeds were covered with soil and the planter boxes placed onto a lab cart with overhead lighting set at 14 hours on and 10 hours off and a room temperature of 21° C. Three replicate planter boxes (total of 30 seeds) were treated and three control planter boxes to which no CAPTURE® Insecticide was applied were included in the test. Each planter box was watered with 146 mL of tap water and re-watered with 50 mL of tap water along the furrow at 4 days after treatment (DAT). At four DAT there were 19 emerged seedlings in the treated planter boxes and 16 emerged seedlings in the untreated planter boxes. At five DAT all seeds had emerged and the seedlings were removed from the soil and the roots were gently rinsed in tap water to remove the soil. The seedlings were placed onto paper and the roots and shoots were measured from the seed to the tip of the tallest leaf and from the seed to the tip of the longest root and each seedling was weighed. Table 1 below summarizes the average shoot height; root length and seedling wet weight of the treated and untreated seeds.

TABLE 1
Corn Shoot Height, Root Length and Seedling Weight

| | Rate of | | | |
|---|---|---|---|---|
| | Application | Shoot Height | Root Length | Seedling |
| Treatment | (gai/ha) | (cm) | (cm) | Weight (gm) |
| CAPTURE ® | 269 | 3.2 | 11.7 | 0.69 |
| LFR | | | | |
| Control | 0 | 2.9 | 11.2 | 0.65 |

### Example 2

### Corn Seedling Growth Enhancement Using CAPTURE® LFR Insecticide or Bifenthrin Technical

In a manner similar to Example 1, Corn seeds were treated in-furrow with different rates of CAPTURE® LFR or test solutions of technical bifenthrin (96% purity) dissolved in acetone and diluted with distilled water containing 0.1% Tween® 20 (Polyoxylethylene-sorbitan monolaurate available from SigmaAldrich). There were 8 replications of each treatment including the untreated control. Table 2 below summarizes the average shoot height, root length and seedling weight of the treated and untreated seeds.

TABLE 2
Corn Shoot Height, Root Length and Seedling Weight

| | Rate of | Shoot | | |
|---|---|---|---|---|
| | Application | Height | Root Length | Seedling Weight |
| Treatment | (gai/ha) | (cm) | (cm) | (gm) |
| CAPTURE ® | 4.68* | 9.7 | 21.5 | 1.2 |
| LFR | 18.75 | 9.6 | 21.7 | 1.2 |
| | 75 | 9.7 | 22.0 | 1.2 |
| | 300 | 9.4 | 23.5 | 1.2 |
| | 1200 | 9.5 | 22.3 | 1.2 |
| Technical | 4.68 | 9.2 | 20.8 | 1.1 |
| Bifenthrin | 18.75 | 9.5 | 20.7 | 1.1 |
| | 75** | 9.6 | 21.5 | 1.2 |
| | 300 | 9.5 | 21.8 | 1.1 |
| | 1200** | 9.9 | 22.3 | 1.2 |
| Control | 0 | 9.0 | 22.2 | 1.1 |

*one seed did not germinate
**two seedlings had the shoot broken off

As can be seen from the data in Tables 1 and 2 the compositions of the present invention when applied to corn seeds at the time of planting as an in-furrow application with no insect or weed pressure significantly improved the time of emergence, shoot height, root growth and seedling weight as compared to untreated controls.

What is claimed is:

1. A method of improving the growth of a plant comprising applying a plant growth effective amount of bifenthrin to plant propagation material in the absence of insect pest pressure.

2. The method of claim 1 wherein the plant propagation material is seed.

3. The method of claim 1 wherein the bifenthrin is applied at a rate of 4 g ai/ha to 1200 g ai/ha.

4. The method of claim 3 wherein the bifenthrin is applied at a rate of from 4 g ai/ha to about 300 g ai/ha.

5. The method of claim 1 wherein such plants is selected from the group consisting of brassicas, corn, cucurbits, dried beans and peas, eggplant, lettuce; leafy brassicas/turnip greens, sod, soybeans, spinach, succulent peas and beans, tobacco, tomatoes, and tuberous and corm vegetables.

6. The method of claim 5 wherein such plant is corn.
